(19) United States
(12) Patent Application Publication
(10) Pub. No.: US 2024/0282497 A1
(43) Pub. Date: Aug. 22, 2024

(54) MULTILAYER INDUCTOR

(71) Applicant: TDK CORPORATION, Tokyo (JP)

(72) Inventors: Takuya SATO, Tokyo (JP); Kazuhiro TSUKAMOTO, Tokyo (JP)

(73) Assignee: TDK CORPORATION, Tokyo (JP)

(21) Appl. No.: 18/540,986

(22) Filed: Dec. 15, 2023

(30) Foreign Application Priority Data
Feb. 22, 2023 (JP) 2023-025894

(51) Int. Cl. H01F 17/00

(52) U.S. Cl. CPC H01F 17/0013

(57) ABSTRACT

An inductor includes a first inductor portion, and a second inductor portion that is connected in parallel with the first inductor portion. Each of the first and second inductor portions includes a conductor structure wound about an axis extending in a direction orthogonal to a stacking direction of a stack. The conductor structure of the first inductor portion includes first to third structures. The first structure includes three columnar conductors. The second structure includes three columnar conductors.

### CROSS REFERENCE TO RELATED APPLICATIONS

This application claims the benefit of Japanese Priority Patent Application No. 2023-25894 filed on Feb. 22, 2023, the entire contents of which are incorporated herein by reference.

### BACKGROUND OF THE INVENTION

### 1. Field of the Invention

The present invention relates to a multilayer inductor which is formed inside a stack including a plurality of dielectric layers stacked together and is wound about an axis extending in a direction orthogonal to a stacking direction of the plurality of dielectric layers.

### 2. Description of the Related Art

Compact mobile communication apparatuses are generally configured to use a single common antenna for a plurality of applications that use different systems and have different service frequency bands, and to use a branching filter to separate a plurality of signals received and transmitted by the antenna from each other.

A branching filter for separating a first signal of a frequency within a first frequency band and a second signal of a frequency within a second frequency band higher than the first frequency band from each other typically includes a common port, a first signal port, a second signal port, a first filter provided in a first signal path leading from the common port to the first signal port, and a second filter provided in a second signal path leading from the common port to the second signal port. As the first and second filters, LC filters including inductors and capacitors are used, for example.

As a branching filter suitable for miniaturization, one using a stack including a plurality of dielectric layers and a plurality of conductor layers stacked together is known. As an inductor used for a branching filter using a stack, a conductor structure type inductor is known. The conductor structure type inductor is an inductor including a conductor layer and a plurality of through holes and is wound about an axis orthogonal to a stacking direction of a plurality of dielectric layers. The conductor structure type inductor includes a plurality of columnar conductors constituted by a plurality of through holes connected in series and at least one conductor layer connected to the plurality of columnar conductors.

An inductor to be used for a filter is required to have a large Q value. A conductor structure type inductor has a structure suitable for having a large Q value.

US 2019/0173447 A1 discloses a multilayered LC filter including a conductor structure type inductor. The inductor is constituted by a line-shaped conductor pattern and a plurality of via conductors.

Here, consider to reduce the inductance of the conductor structure type inductor while increasing the Q value. For example, by increasing the width of a conductor layer of the inductor while maintaining the distance from one end to the other end of the inductor, the inductance can be reduced. However, when the area of the conductor layer is large, this causes a problem that cracks are likely to occur in a stack.

### SUMMARY OF THE INVENTION

An object of the present invention is to provide a multilayer inductor that can prevent cracks from occurring in a stack while increasing a Q value and reducing inductance.

A multilayer inductor of the present invention includes a first inductor portion, a second inductor portion connected in parallel with the first inductor portion, and a stack for integrating the first inductor portion and the second inductor portion, the stack including a plurality of dielectric layers stacked together. Each of the first inductor portion and the second inductor portion includes a conductor structure wound about an axis extending in a direction orthogonal to a stacking direction of the plurality of dielectric layers. The conductor structure includes a first structure and a second structure each extending in a direction parallel to the stacking direction and a third structure extending along a plane intersecting the stacking direction and provided between the first structure and the second structure in a circuit configuration.

Each of the first structure and the second structure includes at least one columnar conductor extending in the direction parallel to the stacking direction. The at least one columnar conductor of at least one of the first structure and the second structure of the first inductor portion includes a plurality of columnar conductors arranged with certain space from each other in the direction orthogonal to the stacking direction.

A multilayer inductor of the present invention includes a first inductor portion, and a second inductor portion that is connected in parallel with the first inductor portion. The at least one columnar conductor of at least one of the first structure and the second structure of the first inductor portion includes a plurality of columnar conductors arranged with certain space from each other in the direction orthogonal to the stacking direction. Hence, according to the present invention, it is possible to prevent cracks from occurring in a stack while increasing a Q value and reducing inductance.

Other and further objects, features and advantages of the present invention will appear more fully from the following description.

### BRIEF DESCRIPTION OF THE DRAWINGS

FIG. 1 is a circuit diagram showing a circuit configuration of a branching filter including a multilayer inductor according to one embodiment of the present invention.

FIG. 2 is a perspective view showing an appearance of the branching filter including the multilayer inductor according to the embodiment of the present invention.

FIG. 3A to FIG. 3C are explanatory diagrams showing respective patterned surfaces of first to third dielectric layers of a stack of the branching filter in the embodiment of the present invention.

FIG. 4A to FIG. 4C are explanatory diagrams showing respective patterned surfaces of fourth to sixth dielectric layers of the stack of the branching filter in the embodiment of the present invention.

FIG. 5A to FIG. 5C are explanatory diagrams showing respective patterned surfaces of seventh to ninth dielectric layers of the stack of the branching filter in the embodiment of the present invention.

FIG. 6A is an explanatory diagram showing a patterned surface of tenth to thirteenth dielectric layers of the stack of the branching filter in the embodiment of the present invention.

FIG. 6B is an explanatory diagram showing a patterned surface of a fourteenth dielectric layer of the stack of the branching filter in the embodiment of the present invention.

FIG. 6C is an explanatory diagram showing a patterned surface of a fifteenth dielectric layer of the stack of the branching filter in the embodiment of the present invention.

FIG. 7A is an explanatory diagram showing a patterned surface of a sixteenth dielectric layer of the stack of the branching filter in the embodiment of the present invention.

FIG. 7B is an explanatory diagram showing a patterned surface of a seventeenth dielectric layer of the stack of the branching filter in the embodiment of the present invention.

FIG. 7C is an explanatory diagram showing a patterned surface of eighteenth to twenty-first dielectric layers of the stack of the branching filter in the embodiment of the present invention.

FIG. 8A and FIG. 8B are explanatory diagrams showing respective patterned surfaces of twenty-second and twenty-third dielectric layers of the stack of the branching filter in the embodiment of the present invention.

FIG. 9 is a perspective view showing an internal structure of the stack of the branching filter in the embodiment of the present invention.

FIG. 10 is a plan view showing a part of the internal structure of the stack of the branching filter in the embodiment of the present invention.

FIG. 11 is a perspective view showing a part of the internal structure of the stack of the branching filter in the embodiment of the present invention.

FIG. 12 is a perspective view showing a first multilayer inductor according to the embodiment of the present invention.

FIG. 13 is a perspective view showing a second multilayer inductor according to the embodiment of the present invention.

FIG. 14 is a characteristic chart showing pass attenuation characteristics of the branching filter in the embodiment of the present invention.

FIG. 15 is a perspective view showing a first variation of the first multilayer inductor according to the embodiment of the present invention.

FIG. 16 is a perspective view showing a second variation of the first multilayer inductor according to the embodiment of the present invention.

FIG. 17 is a perspective view showing a third variation of the first multilayer inductor according to the embodiment of the present invention.

FIG. 18 is a perspective view showing a fourth variation of the first multilayer inductor according to the embodiment of the present invention.

### DETAILED DESCRIPTION OF THE PREFERRED EMBODIMENTS

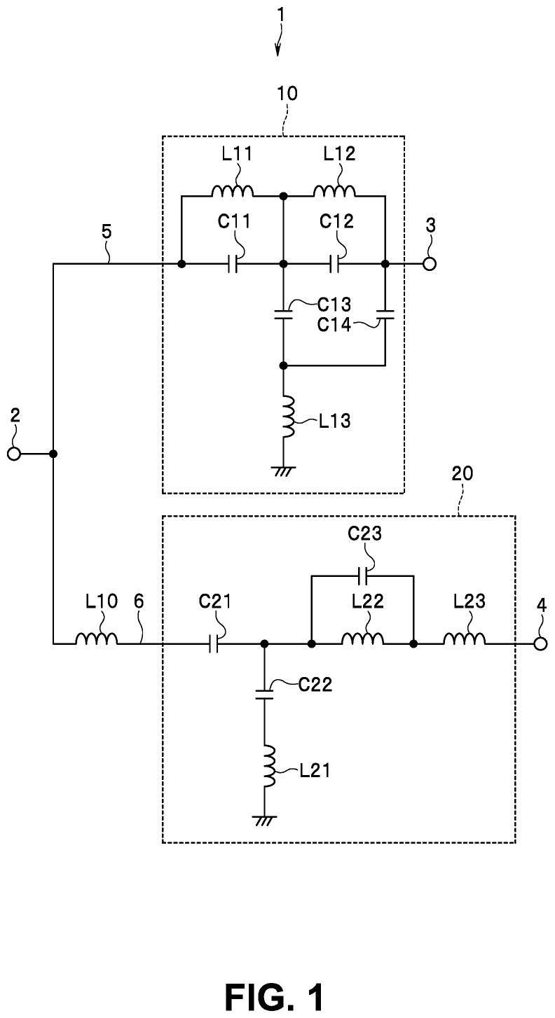

An embodiment of the present invention will now be described in detail with reference to the drawings. First, a configuration of a branching filter 1 including a multilayer inductor according to the embodiment of the present invention will be outlined with reference to FIG. 1. FIG. 1 is a circuit diagram showing a circuit configuration of the branching filter 1. The branching filter 1 in the present embodiment is a diplexer. The branching filter 1 includes a common terminal 2, a first signal terminal 3, a second signal terminal 4, a first filter 10, and a second filter 20.

The first filter 10 is provided between the common terminal 2 and the first signal terminal 3 in a circuit configuration. The second filter 20 is provided between the common terminal 2 and the second signal terminal 4 in the circuit configuration. In the present application, the expression of “in the (a) circuit configuration” is used to indicate not layout in physical configuration but layout in the circuit diagram.

The first filter 10 is a filter that selectively passes a signal of a frequency within a first passband and is an LC filter including at least one inductor and at least one capacitor. The second filter 20 is a filter that selectively passes a signal within a second passband higher than the first passband and is an LC filter including at least one inductor and at least one capacitor.

The branching filter 1 further includes a first path 5 connecting the common terminal 2 and the first signal terminal 3, and a second path 6 connecting the common terminal 2 and the second signal terminal 4. The first path 5 is a path leading from the common terminal 2 to the first signal terminal 3 via the first filter 10. The second path 6 is a path leading from the common terminal 2 to the second signal terminal 4 via the second filter 20. The first path 5 and the second path 6 branch between the common terminal 2 and the first and second filters 10 and 20.

The branching filter 1 further includes an inductor L10 provided between the common terminal 2 and the second filter 20 in the circuit configuration. One end of the inductor L10 is connected to the common terminal 2.

Next, an example of configurations of the first and second filters 10 and 20 will be described with reference to FIG. 1. Initially, the configuration of the first filter 10 will be described. The first filter 10 includes inductors L11, L12, and L13 and capacitors C11, C12, C13, and C14. One end of the inductor L11 is connected to the common terminal 2. One end of the inductor L12 is connected to the other end of the inductor L11. The other end of the inductor L12 is connected to the first signal terminal 3.

The capacitor C11 is connected in parallel with the inductor L11. The capacitor C12 is connected in parallel with the inductor L12.

One end of the capacitor C13 is connected to a connection point between the inductor L11 and the inductor L12. One end of the capacitor C14 is connected to the other end of the inductor L12. One end of the inductor L13 is connected to the other ends of the capacitors C13 and C14. The other end of the inductor L13 is connected to the ground.

The inductor L12 is connected, at both ends thereof, to the first path 5. The inductor L12 may form a part of the first path 5. As will be described below, the inductor L12 corresponds to a “multilayer inductor” of the present invention.

Next, the configuration of the second filter 20 will be described. The second filter 20 includes inductors L21, L22, and L23 and capacitors C21, C22, and C23. One end of the capacitor C21 is connected to the other end of the inductor L10. One end of the capacitor C22 is connected to the other end of the capacitor C21. One end of the inductor L21 is connected to the other end of the capacitor C22. The other end of the inductor L21 is connected to the ground.

One end of the inductor L22 is connected to the other end of the capacitor C21. One end of the inductor L23 is connected to the other end of the inductor L22. The other end of the inductor L23 is connected to the second signal terminal 4. The capacitor C23 is connected in parallel with the inductor L22.

The inductor L22 is connected, at both ends thereof, to the second path 6. The inductor L22 may form a part of the second path 6. As will be described below, the inductor L22 corresponds to the “multilayer inductor” of the present invention.

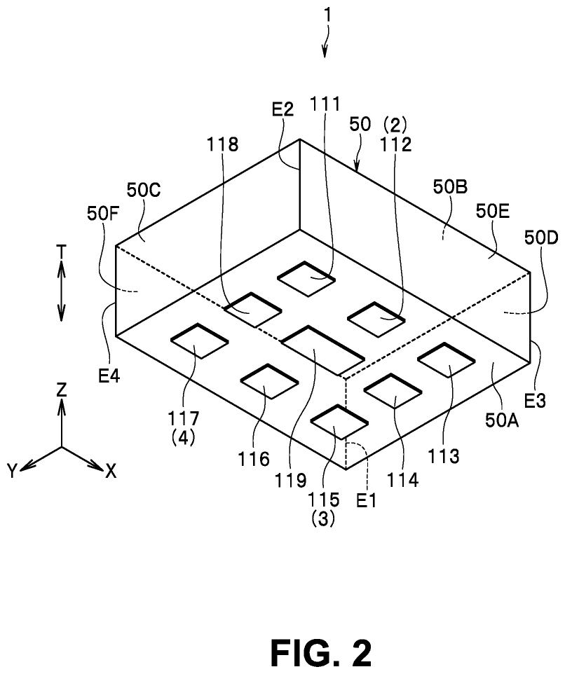

Next, other configurations of the branching filter 1 will be described with reference to FIG. 2. FIG. 2 is a perspective view showing an appearance of the branching filter 1.

The branching filter 1 further includes a stack 50. The stack 50 includes a plurality of dielectric layers and a plurality of conductors (a plurality of conductor layers and a plurality of through holes) stacked together. The stack 50 is for integrating the common terminal 2, the first signal terminal 3, the second signal terminal 4, the first filter 10, and the second filter 20.

The stack 50 has a bottom surface 50A and a top surface 50B located at both ends in a stacking direction T of the plurality of dielectric layers, and four side surfaces 50C to 50F connecting the bottom surface 50A and the top surface 50B. The side surfaces 50C and 50D are opposite to each other, and the side surfaces 50E and 50F are also opposite to each other. The side surfaces 50C to 50F are perpendicular to the top surface 50B and the bottom surface 50A.

Here, X, Y, and Z directions are defined as shown in FIG. 2. The X, Y, and Z directions are orthogonal to one another. In the present embodiment, a direction parallel to the stacking direction T will be referred to as the Z direction. The opposite directions to the X, Y, and Z directions are defined as −X, −Y, and −Z directions, respectively. The expression “when viewed in the stacking direction T” means that an object is viewed from a position away in the Z direction or the −Z direction.

As shown in FIG. 2, the bottom surface 50A is located at the end of the stack 50 in the −Z direction. The top surface 50B is located at the end of the stack 50 in the Z direction. The side surface 50C is located at the end of the stack 50 in the −X direction. The side surface 50D is located at the end of the stack 50 in the X direction. The side surface 50E is located at the end of the stack 50 in the −Y direction. The side surface 50F is located at the end of the stack 50 in the Y direction.

Each of the side surfaces 50E and 50F connects the side surface 50C and the side surface 50D. The stack 50 further has a first end portion E1 located at a position where the side surface 50D and the side surface 50F intersect, a second end portion E2 located at a position where the side surface 50C and the side surface 50E intersect, a third end portion E3 located at a position where the side surface 50D and the side surface 50E intersect, and a fourth end portion E4 located at a position where the side surface 50C and the side surface 50F intersect.

The branching filter 1 further includes electrodes 111, 112, 113, 114, 115, 116, 117, 118, and 119 provided at the bottom surface 50A of the stack 50. The electrodes 111, 112, and 113 are arranged in this order in the X direction at positions closer to the side surface 50E than to the side surface 50F. The electrodes 115, 116, and 117 are arranged in this order in the −X direction at positions closer to the side surface 50F than to the side surface 50E.

The electrode 114 is arranged between the electrode 113 and the electrode 115. The electrode 118 is arranged between the electrode 111 and the electrode 117. The electrode 119 is arranged between the electrode 112 and the electrode 116. The electrode 119 is arranged approximately at the center of the bottom surface 50A.

The electrode 112 corresponds to the common terminal 2, the electrode 115 corresponds to the first signal terminal 3, and the electrode 117 corresponds to the second signal terminal 4. The common terminal 2 and the first and second signal terminals 3 and 4 are thus provided to the bottom surface 50A of the stack 50. Each of the electrodes 111, 113, 114, 116, 118, and 119 is connected to the ground.

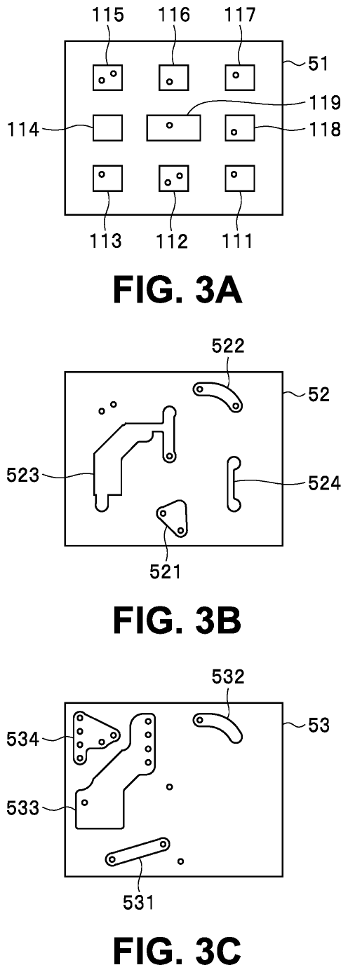

Next, an example of the plurality of dielectric layers, the plurality of conductor layers, and the plurality of through holes constituting the stack 50 will be described with reference to FIG. 3A to FIG. 8B. In this example, the stack 50 includes twenty-three dielectric layers stacked together. The twenty-three dielectric layers will be referred to below as first to twenty-third dielectric layers in the order from bottom to top. The first to twenty-third dielectric layers are denoted by reference numerals 51 to 73, respectively.

In FIG. 3A to FIG. 8A, each circle represents a through hole. The dielectric layers 51 to 72 each have a plurality of through holes. The through holes are each formed by filling a hole intended for a through hole with a conductive paste. Each of the plurality of through holes is connected to an electrode, a conductor layer, or another through hole.

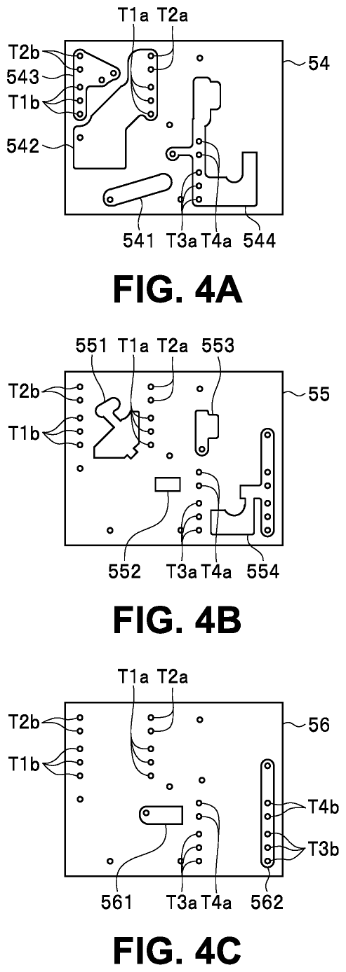

In FIG. 4A to FIG. 7C, a plurality of specific through holes forming a plurality of columnar conductors to be described below among the plurality of through holes are denoted by reference numerals. For a connection relationship between each of the plurality of specific through holes and the conductor layers or another through hole, the connection relationship in a state where the first to twenty-third dielectric layers 51 to 73 are stacked together will be described. Each of the plurality of specific through holes is denoted by the reference numeral of a corresponding columnar conductor.

FIG. 3A shows the patterned surface of the first dielectric layer 51. The electrodes 111 to 119 are formed on the patterned surface of the dielectric layer 51. FIG. 3B shows the patterned surface of the second dielectric layer 52. Conductor layers 521, 523, and 524 and an inductor conductor layer 522 are formed on the patterned surface of the dielectric layer 52. FIG. 3C shows the patterned surface of the third dielectric layer 53. Inductor conductor layers 531 and 532 and conductor layers 533 and 534 are formed on the patterned surface of the dielectric layer 53.

FIG. 4A shows the patterned surface of the fourth dielectric layer 54. An inductor conductor layer 541 and conductor layers 542, 543, and 544 are formed on the patterned surface of the dielectric layer 54. Three through holes denoted by a reference numeral T1a, three through holes denoted by a reference numeral T1b, two through holes denoted by a reference numeral T2a, two through holes denoted by a reference numeral T2b, three through holes denoted by a reference numeral T3a, and two through holes denoted by a reference numeral T4a are formed in the dielectric layer 54.

The three through holes denoted by the reference numeral T1a are through holes for forming three columnar conductors T1a. Note that a through hole denoted by the reference numeral T1a is described as a through hole T1a in the following description for convenience. Through holes denoted by reference numerals other than the through hole T1a are described similarly to the through hole T1a. The through holes denoted by reference numerals other than the through hole T1a are each a through hole for forming a columnar conductor denoted by the reference numeral.

The three through holes T1a formed in the dielectric layer 54 and the three through holes T2a formed in the dielectric layer 54 are connected to the conductor layer 542. The three through holes T1b formed in the dielectric layer 54 and the two through holes T2b formed in the dielectric layer 54 are connected to the conductor layer 543. The three through holes T3a formed in the dielectric layer 54 and the two through holes T4a formed in the dielectric layer 54 are connected to the conductor layer 544.

FIG. 4B shows the patterned surface of the fifth dielectric layer 55. Conductor layers 551, 552, 553, and 554 are formed on the patterned surface of the dielectric layer 55. The three through holes T1a, the three through holes T1b, the two through holes T2a, the two through holes T2b, the three through holes T3a, and the two through holes T4a are formed in the dielectric layer 55.

FIG. 4C shows the patterned surface of the sixth dielectric layer 56. Conductor layers 561 and 562 are formed on the patterned surface of the dielectric layer 56. The three through holes T1a, the three through holes T1b, the two through holes T2a, the two through holes T2b, the three through holes T3a, the three through holes T3b, the two through holes T4a, and the two through holes T4b are formed in the dielectric layer 56. The three through holes T3b formed in the dielectric layer 56 and the two through holes T4b formed in the dielectric layer 56 are connected to the conductor layer 562.

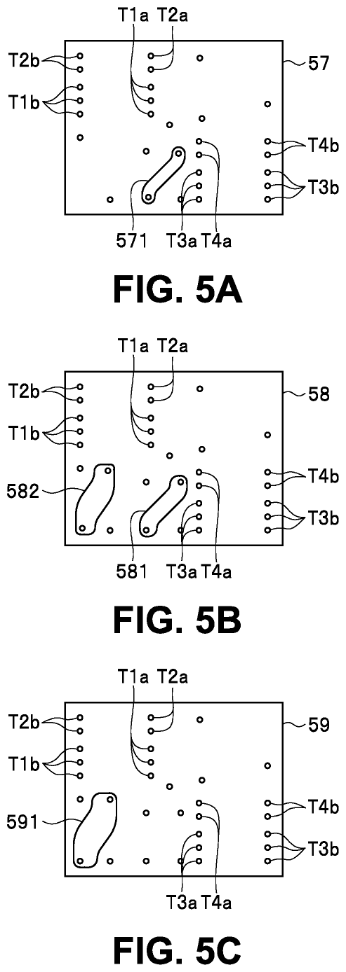

FIG. 5A shows the patterned surface of the seventh dielectric layer 57. An inductor conductor layer 571 is formed on the patterned surface of the dielectric layer 57. FIG. 5B shows the patterned surface of the eighth dielectric layer 58. Inductor conductor layers 581 and 582 are formed on the patterned surface of the dielectric layer 58. FIG. 5C shows the patterned surface of the ninth dielectric layer 59. An inductor conductor layer 591 is formed on the patterned surface of the dielectric layer 59.

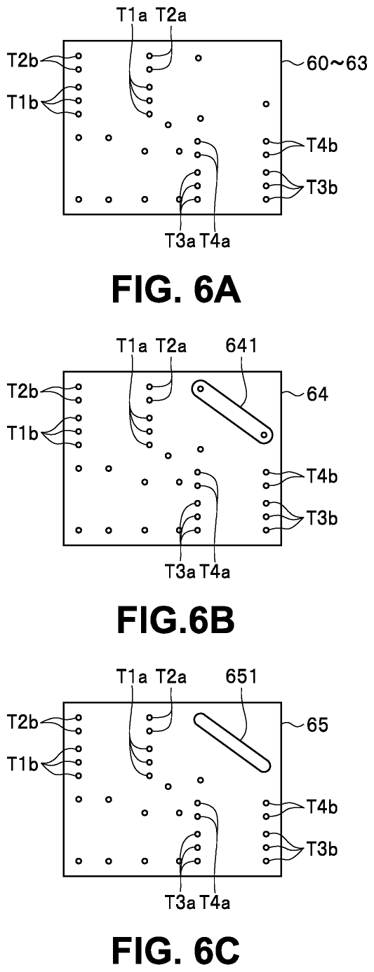

FIG. 6A shows the patterned surface of each of the tenth to thirteenth dielectric layers 60 to 63. No conductor layer is formed on the patterned surface of each of the dielectric layers 60 to 63. FIG. 6B shows the patterned surface of the fourteenth dielectric layer 64. An inductor conductor layer 641 is formed on the patterned surface of the dielectric layer 64. FIG. 6C shows the patterned surface of the fifteenth dielectric layer 65. An inductor conductor layer 651 is formed on the patterned surface of the dielectric layer 65.

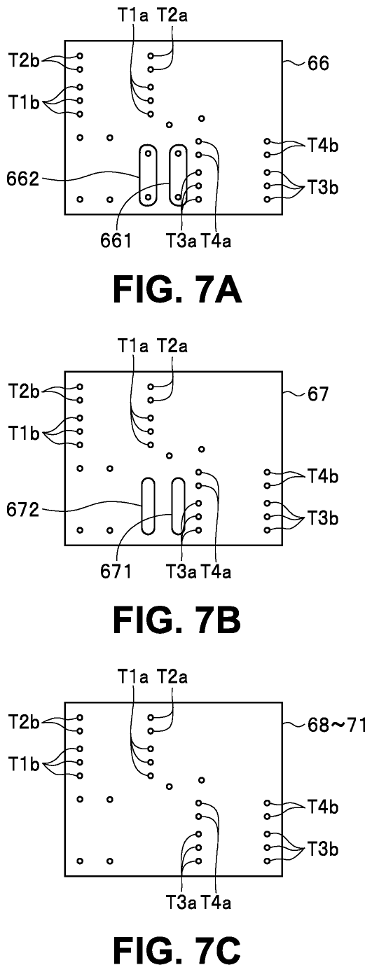

FIG. 7A shows the patterned surface of the sixteenth dielectric layer 66. Inductor conductor layers 661 and 662 are formed on the patterned surface of the dielectric layer 66. FIG. 7B shows the patterned surface of the seventeenth dielectric layer 67. Inductor conductor layers 671 and 672 are formed on the patterned surface of the dielectric layer 67. FIG. 7C shows the patterned surface of each of the eighteenth to twenty-first dielectric layers 68 to 71. No conductor layer is formed on the patterned surface of each of the dielectric layers 68 to 71.

The three through holes T1a, the three through holes T1b, the two through holes T2a, the two through holes T2b, the three through holes T3a, the three through holes T3b, the two through holes T4a, and the two through holes T4b are formed in each of the dielectric layers 57 to 71.

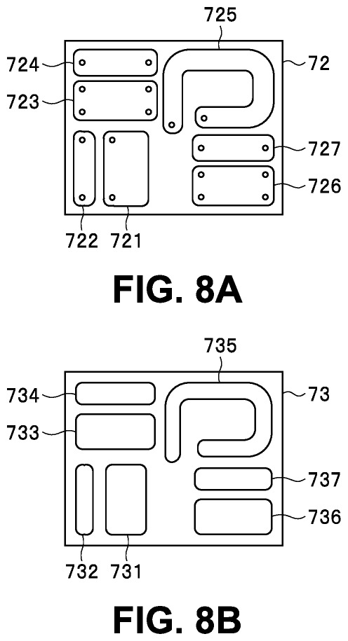

FIG. 8A shows the patterned surface of the twenty-second dielectric layer 72. Inductor conductor layers 721, 722, 723, 724, 725, 726, and 727 are formed on the patterned surface of the dielectric layer 72. Each of the conductor layers 723, 724, 726, and 727 has a first end and a second end located opposite to each other.

The three through holes T1a formed in the dielectric layer 71 are connected to a part near the first end of the conductor layer 723. The three through holes T1b formed in the dielectric layer 71 are connected to a part near the second end of the conductor layer 723.

The two through holes T2a formed in the dielectric layer 71 are connected to a part near the first end of the conductor layer 724. The two through holes T2b formed in the dielectric layer 71 are connected to a part near the second end of the conductor layer 724.

The three through holes T3a formed in the dielectric layer 71 are connected to a part near the first end of the conductor layer 726. The three through holes T3b formed in the dielectric layer 71 are connected to a part near the second end of the conductor layer 726.

The two through holes T4a formed in the dielectric layer 71 are connected to a part near the first end of the conductor layer 727. The two through holes T4b formed in the dielectric layer 71 are connected to a part near the second end of the conductor layer 727.

FIG. 8B shows the patterned surface of the twenty-third dielectric layer 73. Inductor conductor layers 731, 732, 733, 734, 735, 736, and 737 are formed on the patterned surface of the dielectric layer 73.

The stack 50 shown in FIG. 2 is formed by stacking the first to twenty-third dielectric layers 51 to 73 such that the patterned surface of the first dielectric layer 51 serves as the bottom surface 50A of the stack 50 and the surface of the twenty-third dielectric layer 73 opposite to the patterned surface thereof serves as the top surface 50B of the stack 50.

Each of the plurality of through holes shown in FIG. 3A to FIG. 8A is connected to, when the first to twenty-third dielectric layers 51 to 73 are stacked, a conductor layer overlapping in the stacking direction T or to another through hole overlapping in the stacking direction T. Of the plurality of through holes shown in FIG. 3A to FIG. 8A, the ones located within an electrode or a conductor layer are connected to the electrode or conductor layer.

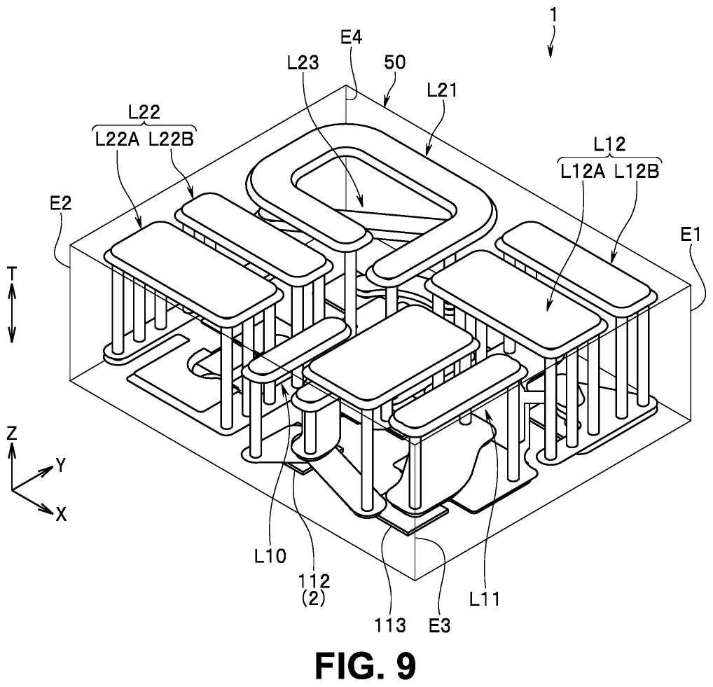

FIG. 9 shows an internal structure of the stack 50 formed by stacking the first to twenty-third dielectric layers 51 to 73. As shown in FIG. 9, the plurality of conductor layers and the plurality of through holes shown in FIG. 3A to 8B are stacked inside the stack 50.

Correspondences between the components of the circuit of the branching filter 1 shown in FIG. 1 and the internal components of the stack 50 shown in FIG. 3A to FIG. 8B will now be described. First, the inductor L10 will be described. The inductor L10 is constituted by inductor conductor layers 571, 581, 661, 662, 671, and 672, a plurality of through holes connecting each of a pair of conductor layers 571 and 581, a pair of conductor layers 661 and 671, and a pair of conductor layers 662 and 672, a plurality of through holes connecting the conductor layer 581 and the conductor layer 661, a plurality of through holes connecting the conductor layer 581 and the conductor layer 662, a plurality of through holes connecting the conductor layer 661 and the conductor layer 521, and a plurality of through holes connecting the conductor layer 662 and the conductor layer 561.

Next, the components of the first filter 10 will be described. The inductor L11 is constituted by inductor conductor layers 582, 591, 721, 722, 731, and 732, a plurality of through holes connecting each of a pair of conductor layers 582 and 591, a pair of conductor layers 721 and 731, and a pair of conductor layers 722 and 732, a plurality of through holes connecting the conductor layer 591 and the conductor layer 721, a plurality of through holes connecting the conductor layer 591 and the conductor layer 722, a plurality of through holes connecting the conductor layer 721 and the conductor layer 541, and a plurality of through holes connecting the conductor layer 722 and the conductor layer 542.

The inductor L12 is constituted by the inductor conductor layers 723, 724, 733, and 734, a plurality of through holes connecting each of a pair of conductor layers 723 and 733 and a pair of conductor layers 724 and 734, and the plurality of through holes denoted by the reference numerals T1a, T1b, T2a, and T2b.

The inductor L13 is constituted by a through hole connecting the electrode 116 and the conductor layer 523 and a through hole connecting the electrode 119 and the conductor layer 523.

The capacitor C11 is the sum of floating capacitance generated between the conductor layer 721 and the conductor layer 722 and floating capacitance generated between the conductor layer 731 and the conductor layer 732. The capacitor C12 is constituted by the conductor layers 542 and 551 and the dielectric layer 54 interposed between those conductor layers. The capacitor C13 is constituted by the conductor layers 523 and 533 and the dielectric layer 52 interposed between those conductor layers. The capacitor C14 is floating capacitance generated between the electrode 114 and the electrode 115, the conductor layer 534, or the conductor layer 543.

Next, the components of the second filter 20 will be described. The inductor L21 is constituted by the inductor conductor layers 725 and 735 and a plurality of through holes connecting the conductor layer 725 and the conductor layer 735.

The inductor L22 is constituted by the inductor conductor layers 726, 727, 736, and 737, a plurality of through holes connecting each of a pair of conductor layers 726 and 736 and a pair of conductor layers 727 and 737, and the plurality of through holes denoted by the reference numerals T3a, T3b, T4a, and T4b.

The inductor L23 is constituted by inductor conductor layers 522, 532, 641, and 651, a plurality of through holes connecting each of a pair of conductor layers 522 and 532 and a pair of conductor layers 641 and 651, a plurality of through holes connecting the conductor layer 532 and the conductor layer 641, and a plurality of through holes connecting the conductor layer 641 and the conductor layer 562.

The capacitor C21 is constituted by the conductor layers 552 and 561 and the dielectric layer 55 interposed between those conductor layers. The capacitor C22 is constituted by the conductor layers 544 and 553 and the dielectric layer 54 interposed between those conductor layers. The capacitor C23 is constituted by the conductor layers 544 and 554 and the dielectric layer 54 interposed between those conductor layers.

Next, the multilayer inductor according to the present embodiment will be described. In the examples shown in FIG. 1 to FIG. 9, each of the inductor L12 and the inductor L22 corresponds to the “multilayer inductor” of the present invention. In the following, the inductor L12 is also referred to as a first multilayer inductor, and the inductor L22 is also referred to as a second multilayer inductor. The inductors L12 and L22 are integrated into the stack 50.

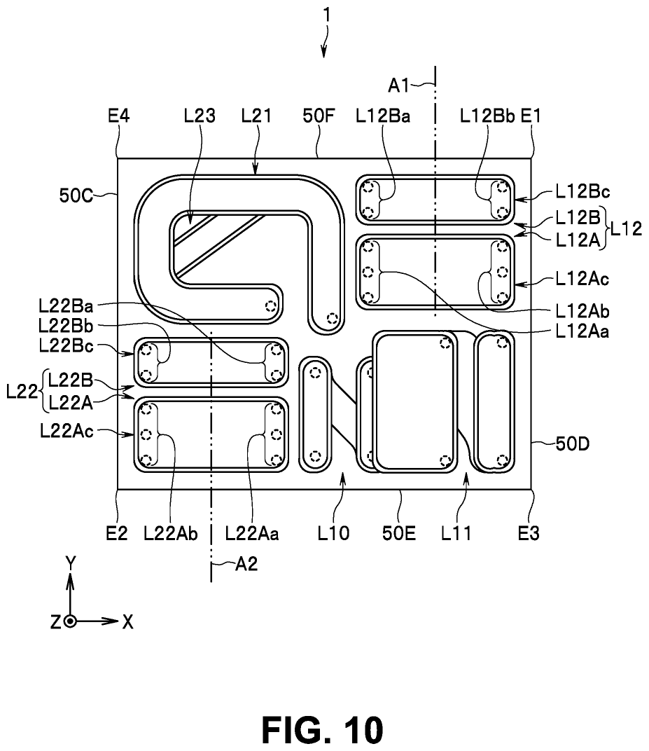

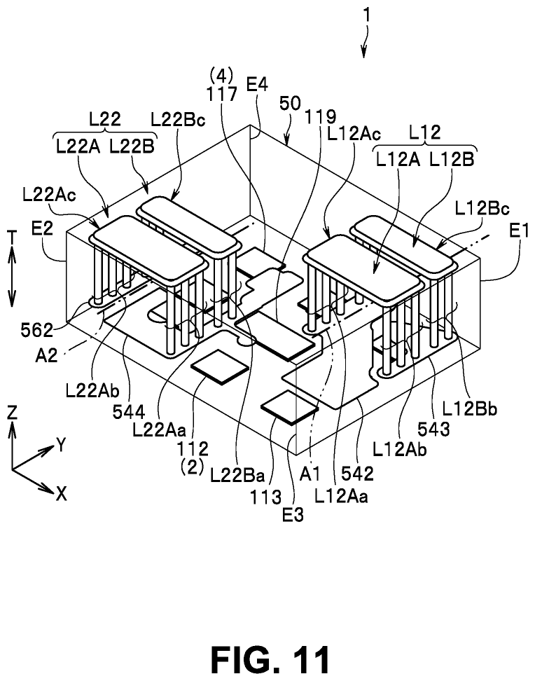

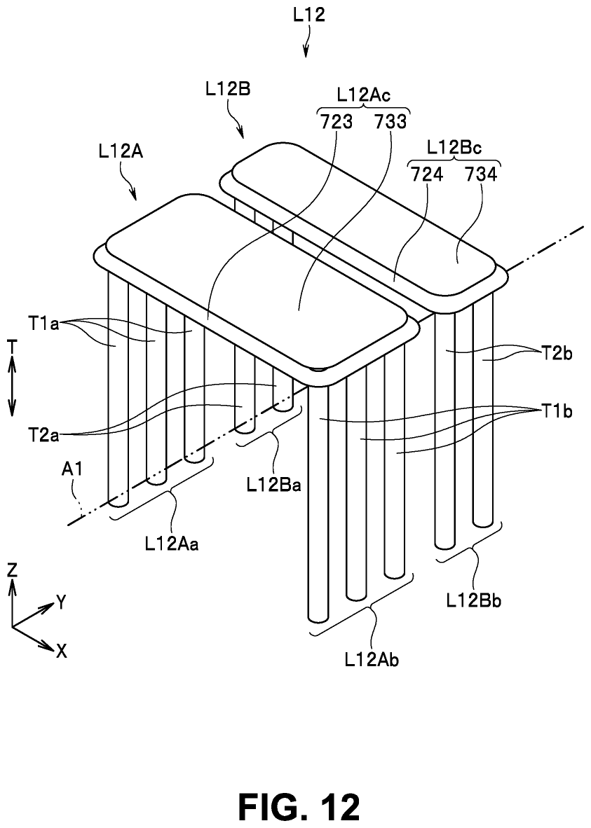

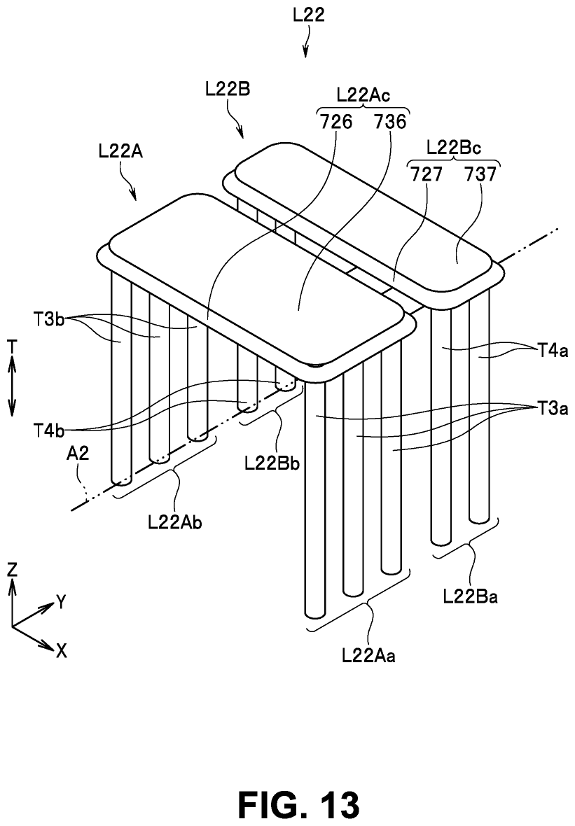

In the following, structural features of the inductors L12 and L22 will be described with reference to FIG. 2 to FIG. 13. FIG. 10 is a plan view showing a part of the internal structure of the stack 50 shown in FIG. 9. FIG. 11 is a perspective view showing a part of the internal structure of the stack 50 shown in FIG. 9. FIG. 12 is a perspective view showing the first multilayer inductor, in other words, the inductor L12. FIG. 13 is a perspective view showing the second multilayer inductor, in other words, the inductor L22.

As shown in FIG. 10 to FIG. 13, each of the inductors L12 and L22 is wound about an axis extending in a direction orthogonal to the stacking direction T. In particular, in the present embodiment, the inductor L12 is a conductor structure type inductor wound about a first axis A1. The inductor L22 is a conductor structure type inductor wound about a second axis A2. The first axis A1 and the second axis A2 may be parallel to each other. In the examples shown in FIG. 10 to FIG. 13, each of the first axis A1 and the second axis A2 extends in a direction parallel to the Y axis.

As shown in FIG. 9 to FIG. 11, the inductor L12 is arranged at a position closer to a first end portion E1 of the stack 50 than to a second end portion E2 of the stack 50. Further, the inductor L12 is preferably arranged at a position closer to the first end portion E1 of the stack 50 than to third and fourth end portions E3 and E4 of the stack 50. The inductor L22 is arranged at a position closer to the second end portion E2 of the stack 50 than to the first end portion E1 of the stack 50. Further, the inductor L22 is preferably arranged at a position closer to the second end portion E2 of the stack 50 than to the third and fourth end portions E3 and E4 of the stack 50.

In particular, in the present embodiment, the inductors L12 and L22 are arranged to intersect a virtual straight line (diagonal line) linking the first end portion E1 and the second end portion E2 when viewed in the stacking direction T. In particular, in the present embodiment, the inductors L12 and L22 are arranged so as not to overlap each other when viewed in the Y direction. Further, the inductors L12 and L22 may be arranged so as not to overlap each other when viewed in the X direction.

In the examples shown in FIG. 9 and FIG. 10, no other element is arranged between the inductor L12 and the side surface 50D and between the inductor L12 and the side surface 50F. However, as long as the above requirements related to arrangement of the inductor L12 are satisfied, any other element may be arranged between the inductor L12 and the side surface 50D or the side surface 50F. Similarly, in the examples shown in FIG. 9 and FIG. 10, no other element is arranged between the inductor L22 and the side surface 50C and between the inductor L22 and the side surface 50E. However, as long as the above requirements related to arrangement of the inductor L22 are satisfied, any other element may be arranged between the inductor L22 and the side surface 50C or the side surface 50E.

Each of the inductors L12 and L22 includes a first structure and a second structure each extending in a direction parallel to the stacking direction T and a third structure extending along a plane intersecting the stacking direction T and provided between the first structure and the second structure in the circuit configuration. The first to third structures will be described in detail below.

First, the first to third structures of the inductor L12 will be described. As shown in FIG. 9 to FIG. 12, the inductor L12 includes a first inductor portion L12A, and a second inductor portion L12B connected in parallel with the first inductor portion L12A. Each of the first and second inductor portions L12A and L12B includes a conductor structure wound about the first axis A1.

The conductor structure of the first inductor portion L12A is also a rectangular or approximately rectangular winding. For the rectangular or approximately rectangular winding, the number of windings may be counted, when the winding is regarded as a rectangle, as ¼ per side of the rectangle. The number of windings of the conductor structure of the first inductor portion L12A is ¾.

The conductor structure of the first inductor portion L12A includes a first structure L12Aa and a second structure L12Ab each extending in a direction parallel to the stacking direction T, and a third structure L12Ac extending along a plane intersecting the stacking direction T. The third structure L12Ac is provided between the first structure L12Aa and the second structure L12Ab in the circuit configuration. In the present embodiment, the third structure L12Ac connects the first structure L12Aa and the second structure L12Ab.

Each of the first and second structures L12Aa and L12Ab includes at least one columnar conductor extending in a direction parallel to the stacking direction T. The columnar conductor is a structure constituted by a plurality of through holes being connected in series. The at least one columnar conductor of at least one of the first and second structures L12Aa and L12Ab includes a plurality of columnar conductors arranged with certain space from each other in the direction orthogonal to the stacking direction T.

As shown in FIG. 12, in the present embodiment, the first structure L12Aa includes the three columnar conductors T1a arranged with certain space from each other in a direction orthogonal to the stacking direction T. The three columnar conductors T1a are constituted by the plurality of through holes formed in the dielectric layers 54 to 71 and denoted by the reference numeral T1a.

As shown in FIG. 12, in the present embodiment, the second structure L12Ab includes the three columnar conductors T1b arranged with certain space from each other in a direction orthogonal to the stacking direction T. The three columnar conductors T1b are constituted by the plurality of through holes formed in the dielectric layers 54 to 71 and denoted by the reference numeral T1b.

As shown in FIG. 12, the third structure L12Ac includes the conductor layers 723 and 733 stacked together in the stacking direction T and electrically connected to each other. The area of the conductor layer 723 is larger than the area of the conductor layer 733. The conductor layer 733 is arranged inside an outer edge of the conductor layer 723 when viewed in the stacking direction T. The shape of the conductor layer 733 when viewed in the stacking direction T is similar to the shape of the conductor layer 723 when viewed in the stacking direction T.

The conductor structure of the second inductor portion L12B is also a rectangular or approximately rectangular winding. The number of windings of the conductor structure of the second inductor portion L12B is ¾. Since the second inductor portion L12B is connected in parallel with the first inductor portion L12A, the substantial number of windings of the inductor L12 is ¾.

The conductor structure of the second inductor portion L12B includes a first structure L12Ba and a second structure L12Bb each extending in a direction parallel to the stacking direction T and a third structure L12Bc extending along a plane intersecting the stacking direction T. The third structure L12Bc is provided between the first structure L12Ba and the second structure L12Bb in the circuit configuration. In the present embodiment, the third structure L12Bc connects the first structure L12Ba and the second structure L12Bb.

Each of the first and second structures L12Ba and L12Bb includes at least one columnar conductor extending in a direction parallel to the stacking direction T. The at least one columnar conductor of at least one of the first and second structures L12Ba and L12Bb includes a plurality of columnar conductors arranged with certain space from each other in the direction orthogonal to the stacking direction T.

As shown in FIG. 12, in the present embodiment, the first structure L12Ba includes the two columnar conductors T2a arranged with certain space from each other in a direction orthogonal to the stacking direction T. The two columnar conductors T2a are constituted by the plurality of through holes formed in the dielectric layers 54 to 71 and denoted by the reference numeral T2a.

As shown in FIG. 12, in the present embodiment, the second structure L12Bb includes the two columnar conductors T2b arranged with certain space from each other in a direction orthogonal to the stacking direction T. The two columnar conductors T2b are constituted by the plurality of through holes formed in the dielectric layers 54 to 71 and denoted by the reference numeral T2b.

As shown in FIG. 12, the third structure L12Bc includes the conductor layers 724 and 734 stacked together in the stacking direction T and electrically connected to each other. The area of the conductor layer 724 is larger than the area of the conductor layer 734. The conductor layer 734 is arranged inside an outer edge of the conductor layer 724 when viewed in the stacking direction T. The shape of the conductor layer 734 when viewed in the stacking direction T is similar to the shape of the conductor layer 724 when viewed in the stacking direction T.

Next, the first to third structures of the inductor L22 will be described. As shown in FIG. 9 to FIG. 11 and FIG. 13, the inductor L22 includes a first inductor portion L22A and a second inductor portion L22B connected in parallel with the first inductor portion L22A. Each of the first and second inductor portions L22A and L22B includes a conductor structure wound about the second axis A2.

The configuration of the conductor structure of the first inductor portion L22A is basically the same as the configuration of the conductor structure of the first inductor portion L12A. By replacing the first inductor portion L12A, the first structure L12Aa, the second structure L12Ab, the third structure L12Ac, the conductor layers 723 and 733, the reference numerals T1a and T1b, and FIG. 12 in the description of the configuration of the conductor structure of the first inductor portion L12A respectively with the first inductor portion L22A, a first structure L22Aa, a second structure L22Ab, a third structure L22Ac, the conductor layers 726 and 736, the reference numerals T3a and T3b, and FIG. 13, this serves as description of the configuration of the conductor structure of the first inductor portion L22A except for the following respect. In the conductor structure of the first inductor portion L22A, the three columnar conductors T3b are constituted by the plurality of through holes formed in the dielectric layers 56 to 71 and denoted by the reference numeral T3b.

The configuration of the conductor structure of the second inductor portion L22B is basically the same as the configuration of the conductor structure of the second inductor portion L12B. By replacing the second inductor portion L12B, the first structure L12Ba, the second structure L12Bb, the third structure L12Bc, the conductor layers 724 and 734, the reference numerals T2a and T2b, and FIG. 12 in the description of the configuration of the conductor structure of the second inductor portion L12B respectively with the second inductor portion L22B, a first structure L22Ba, a second structure L22Bb, a third structure L22Bc, the conductor layers 727 and 737, the reference numerals T4a and T4b, and FIG. 13, this serves as description of the configuration of the conductor structure of the second inductor portion L22B except for the following respect. In the conductor structure of the second inductor portion L22B, the two columnar conductors T4b are constituted by the plurality of through holes formed in the dielectric layers 56 to 71 and denoted by the reference numeral T4b.

Next, structural features related to the columnar conductors included in the inductors L12 and L22 will be described. In the present embodiment, the number of the columnar conductors in the first inductor portion L12A is 6, and the number of the columnar conductors in the second inductor portion L12B is four. Hence, in the present embodiment, the number of the columnar conductors in the first inductor portion L12A is larger than the number of the columnar conductors in the second inductor portion L12B. However, the numbers of columnar conductors included in the first and second inductor portions L12A and L12B are not limited to the above-described examples. For example, as will be described below with reference to variations, the numbers of columnar conductors in the first inductor portion L12A and the columnar conductors in the second inductor portion L12B may be the same. Alternatively, as will be described below with reference to variations, the number of columnar conductors in the second inductor portion L12B may be two. In other words, the first structure L12Ba of the second inductor portion L12B may be constituted by one columnar conductor T2a, and the second structure L12Bb of the second inductor portion L12B may be constituted by one columnar conductor T2b.

The three columnar conductors T1a in the first structure L12Aa of the first inductor portion L12A are arranged in a direction orthogonal to the stacking direction T. Similarly, the three columnar conductors T1b in the second structure L12Ab of the first inductor portion L12A are arranged in a direction orthogonal to the stacking direction T. In particular, in the present embodiment, the above-described direction is a short-side direction of the third structure L12Ac of the first inductor portion L12A, in other words, a direction parallel to the Y direction. Note that at least one of the first structure L12Aa and the second structure L12Ab may include a plurality of columnar conductors arranged in a direction intersecting the short-side direction of the third structure L12Ac (direction parallel to the Y direction), instead of or in addition to the above-described columnar conductors. An example in which each of the first structure L12Aa and the second structure L12Ab includes a plurality of columnar conductors arranged in a direction intersecting a short-side direction of the third structure L12Ac will be described below as a variation.

The two columnar conductors T2a in the first structure L12Ba of the second inductor portion L12B are arranged in a direction orthogonal to the stacking direction T. Similarly, the two columnar conductors T2b in the second structure L12Bb of the second inductor portion L12B are arranged in a direction orthogonal to the stacking direction T. In particular, in the present embodiment, the above-described direction is a short-side direction of the third structure L12Bc of the second inductor portion L12B, in other words, a direction parallel to the Y direction. Note that at least one of the first structure L12Ba and the second structure L12Bb may include a plurality of columnar conductors arranged in a direction intersecting the short-side direction of the third structure L12Bc (direction parallel to the Y direction), instead of or in addition to the above-described columnar conductors.

In the present embodiment, the three columnar conductors T1a and the two columnar conductors T2a are arranged in a direction orthogonal to the stacking direction T. Similarly, the three columnar conductors T1b and the two columnar conductors T2b are arranged in a direction orthogonal to the stacking direction T. In particular, in the present embodiment, the above-described direction is a direction parallel to the Y direction.

Here, a configuration of the inductor L12 will be described by focusing on the columnar conductors T1a, T1b, T2a, and T2b and the conductor layers 723 and 724. The conductor layers 723 and 724 are arranged with certain space from each other when viewed in the stacking direction T. The three columnar conductors T1a and the three columnar conductors T1b are electrically connected by the conductor layer 723. The two columnar conductors T2a and the two columnar conductors T2b are electrically connected by the conductor layer 724.

The above descriptions about the columnar conductors in the first and second inductor portions L12A and L12B also apply to the columnar conductors in the first and second inductor portions L22A and L22B.

Next, structural features related to the third structures L12Ac, L12Bc, L22Ac, and L22Bc will be described. The third structures L12Ac, L12Bc, L22Ac, and L22Bc are arranged at the same position in the stacking direction T. Specifically, the conductor layer 723 of the third structure L12Ac, the conductor layer 724 of the third structure L12Bc, the conductor layer 726 of the third structure L22Ac, and the conductor layer 727 of the third structure L22Bc are arranged at the same position in the stacking direction T, and also the conductor layer 733 of the third structure L12Ac, the conductor layer 734 of the third structure L12Bc, the conductor layer 736 of the third structure L22Ac, and the conductor layer 737 of the third structure L22Bc are arranged at the same position in the stacking direction T.

The short-side-direction size of the third structure L12Ac is the same as the short-side-direction size of the conductor layer 723, and the short-side-direction size of the third structure L12Bc is the same as the short-side-direction size of the conductor layer 724. In the present embodiment, the short-side-direction size of the conductor layer 723 is larger than the short-side-direction size of the conductor layer 724. Hence, the short-side-direction size of the third structure L12Ac is larger than the short-side-direction size of the third structure L12Bc.

The short-side-direction size of the third structure L22Ac is the same as the short-side-direction size of the conductor layer 726, and the short-side-direction size of the third structure L22Bc is the same as the short-side-direction size of the conductor layer 727. In the present embodiment, the short-side-direction size of the conductor layer 726 is larger than the short-side-direction size of the conductor layer 727. Hence, the short-side-direction size of the third structure L22Ac is larger than the short-side-direction size of the third structure L22Bc.

Now, other structural features of the branching filter 1 in the present embodiment will be described. First, structural features of the capacitor C12 connected in parallel with the inductor L12 and the capacitor C24 connected in parallel with the inductor L22 will be described. As described above, the capacitor C12 is constituted by the conductor layers 542 and 551 and the dielectric layer 54 interposed between those conductor layers. The capacitor C24 is constituted by the conductor layers 544 and 554 and the dielectric layer 54 interposed between those conductor layers. The conductor layer 542 of the capacitor C12 and the conductor layer 544 of the capacitor C24 are arranged at the same position in the stacking direction T. The conductor layer 551 of the capacitor C12 and the conductor layer 554 of the capacitor C24 are arranged at the same position in the stacking direction T.

Next, structural features related to the inductor L10 will be described. The inductor L10 is wound about an axis extending in a direction orthogonal to the stacking direction T. In particular, in the present embodiment, the inductor L10 is a conductor structure type inductor wound about an axis parallel to the X direction. The number of windings of the inductor L10 is 7/4.

As shown in FIG. 10, the inductor L10 is arranged between the inductor L12 and the side surface 50E and is also arranged between the inductor L22 and the side surface 50D.

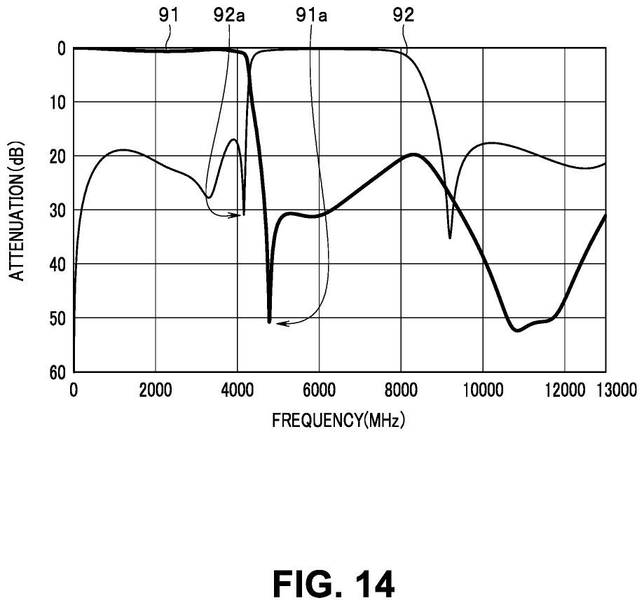

Next, an example of characteristics of the branching filter 1 in the present embodiment will be described. FIG. 14 is a characteristic chart showing the pass attenuation characteristics of the branching filter 1. In FIG. 14, the horizontal axis indicates frequency, and the vertical axis indicates the attenuation. In FIG. 14, a reference numeral 91 indicates the pass attenuation characteristics between the common terminal 2 and the first signal terminal 3. A reference numeral 92 indicates the pass attenuation characteristics between the common terminal 2 and the second signal terminal 4.

The pass attenuation characteristics denoted by the reference numeral 91 substantially shows the pass attenuation characteristics of the first filter 10. In the pass attenuation characteristics denoted by the reference numeral 91, the frequency region in which the absolute value of attenuation takes a value close to 0 indicates the first passband of the first filter 10. The pass attenuation characteristics denoted by the reference numeral 92 substantially shows the pass attenuation characteristics of the second filter 20. In the pass attenuation characteristics denoted by the reference numeral 92, the frequency region in which the absolute value of attenuation takes a value close to 0 indicates the second passband of the second filter 20. FIG. 14 shows the characteristics of the branching filter 1 when a design is made so that the first passband of the first filter 10 includes a frequency band of 3800 MHz to 4200 MHz and the second passband of the second filter 20 includes a frequency band of 4400 MHz to 7125 MHz.

In FIG. 14, an arrow denoted by a reference numeral 91a indicates an attenuation pole formed by the inductor L12 and the capacitor C12. As shown in FIG. 14, no other attenuation pole is formed in the frequency region between the attenuation pole 91a and the first passband. In other words, in the pass attenuation characteristics of the first filter 10, the attenuation pole 91a is an attenuation pole closest to the first passband in a frequency region higher than the first passband.

In FIG. 14, an arrow denoted by a reference numeral 92a indicates an attenuation pole formed by the inductor L22 and the capacitor C24. As shown in FIG. 14, no other attenuation pole is formed in the frequency region between the attenuation pole 92a and the second passband. In other words, in the pass attenuation characteristics of the second filter 20, the attenuation pole 92a is an attenuation pole closest to the second passband in a frequency region lower than the second passband.

Next, the operation and effects of the first and second multilayer inductors, in other words, the inductors L12 and L22, according to the present embodiment will be described. In the present embodiment, the inductor L12 includes a first inductor portion L12A, and a second inductor portion L12B connected in parallel with the first inductor portion L12A. Thus, according to the present embodiment, it is possible to reduce the inductance of the entire inductor L12.

In the present embodiment, each of the first and second inductor portions L12A and L12B includes a conductor structure. In other words, in the present embodiment, each of the first and second inductor portions L12A and L12B is a conductor structure type inductor. Thus, according to the present embodiment, it is possible to increase the Q value of each of the first and second inductor portions L12A and L12B and the Q value of the entire inductor L12.

In the present embodiment, the conductor structure of the first inductor portion L12A includes the third structure L12Ac constituted by the conductor layers 723 and 733, and the conductor structure of the second inductor portion L12B includes the third structure L12Bc constituted by the conductor layers 724 and 734, which are different conductor layers from the conductor layers 723 and 733. Here, consider an inductor of a comparative example constituted only by an inductor portion having a similar configuration as that of the first inductor portion L12A. The inductor of the comparative example includes first to third structures having similar configurations as those of the first to third structures L12Aa to L12Ac. The third structure of the inductor of the comparative example includes two conductor layers connected to each other. By configuring the inductance of the inductor L12 and the inductance of the inductor of the comparative example to be the same as each other for comparison, the area of each of the conductor layers 723, 724, 733, and 734 is smaller than the area of each of the two conductor layers of the inductor of the comparative example. Hence, according to the present embodiment, it is possible to prevent cracks from occurring in the stack 50.

From the above, according to the present embodiment, it is possible to prevent cracks from occurring in the stack 50 while increasing the Q value of the inductor L12 and reducing the inductance of the inductor L12.

In the present embodiment, the number of the columnar conductors in the first inductor portion L12A is larger than the number of the columnar conductors in the second inductor portion L12B. In the present embodiment, the short-side-direction size of the third structure L12Ac of the first inductor portion L12A is larger than the short-side-direction size of the third structure L12Bc of the second inductor portion L12B. According to these, in the present embodiment, the inductance of the first inductor portion L12A is smaller than the inductance of the second inductor portion L12B, and also the amount of current flowing through the first inductor portion L12A is larger than the amount of current flowing through the second inductor portion L12B.

The number of columnar conductors in the second inductor portion L12B is small and the short-side-direction size of the third structure L12Bc, in other words, the width of the conductor layer, is small. Hence, when a signal has passed through the second inductor portion L12B, the loss of the signal is large, but the amount of current flowing through the second inductor portion L12B is small. In contrast, although the amount of current flowing through the first inductor portion L12A is large, the number of columnar conductors in the first inductor portion L12A is large and the short-side-direction size of the third structure L12Ac, in other words, the width of the conductor layer, is large. Hence, when a signal has passed through the first inductor portion L12A, the loss of the signal is relatively small. From these, according to the present embodiment, it is possible to reduce the loss of a signal passing through the inductor L12.

In the present embodiment, the third structure L12Ac of the first inductor portion L12A includes the conductor layers 723 and 733 stacked together in the stacking direction T and electrically connected to each other, and the third structure L12Bc of the second inductor portion L12B includes the conductor layers 724 and 734 stacked together in the stacking direction T and electrically connected to each other. With this, according to the present embodiment, it is possible to reduce the loss of a signal passing through each of the third structures L12Ac and L12Bc compared to a case where each of the third structures L12Ac and L12Bc includes only one conductor layer.

In the present embodiment, by configuring the number of the columnar conductors in the first inductor portion L12A and the number of the columnar conductors in the second inductor portion L12B to be different from each other, it is easy to make fine adjustment of the inductance of the inductor L12 while maintaining a large Q value of the inductor L12.

The above description about the inductor L12 also applies to the inductor L22. Specifically, according to the present embodiment, it is possible to prevent cracks from occurring in the stack 50 while increasing the Q value of the inductor L22 and reducing the inductance of the inductor L22. According to the present embodiment, it is possible to reduce the loss of a signal passing through the inductor L22 and is also easy to make fine adjustment of the inductance of the inductor L22 while maintaining a large Q value of the inductor L22.

### [Variations]

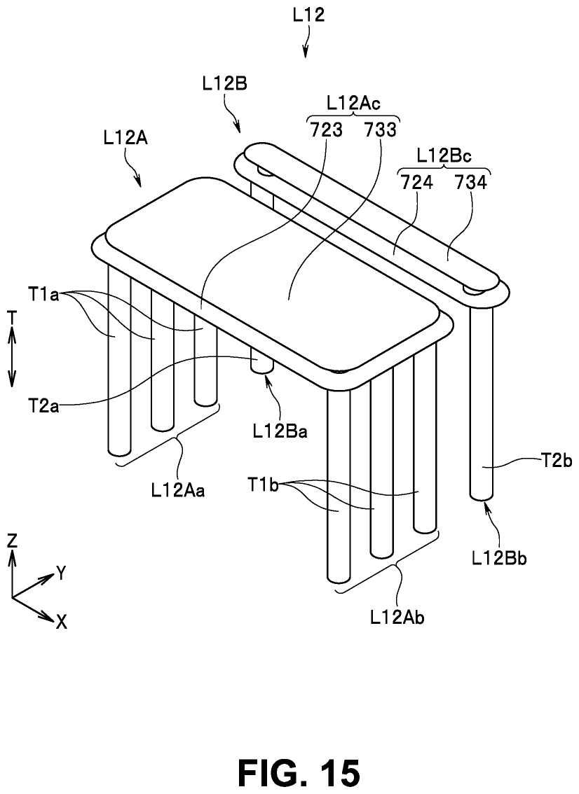

Next, by using the inductor L12 as an example, first to fourth variations of the multilayer inductor according to the present embodiment will be described. First, with reference to FIG. 15, the first variation of the inductor L12 will be described. In the first variation, the first structure L12Ba of the second inductor portion L12B is constituted by one columnar conductor T2a, and the second structure L12Bb of the second inductor portion L12B is constituted by one columnar conductor T2b. In other words, in the first variation, the number of columnar conductors in the second inductor portion L12B is two.

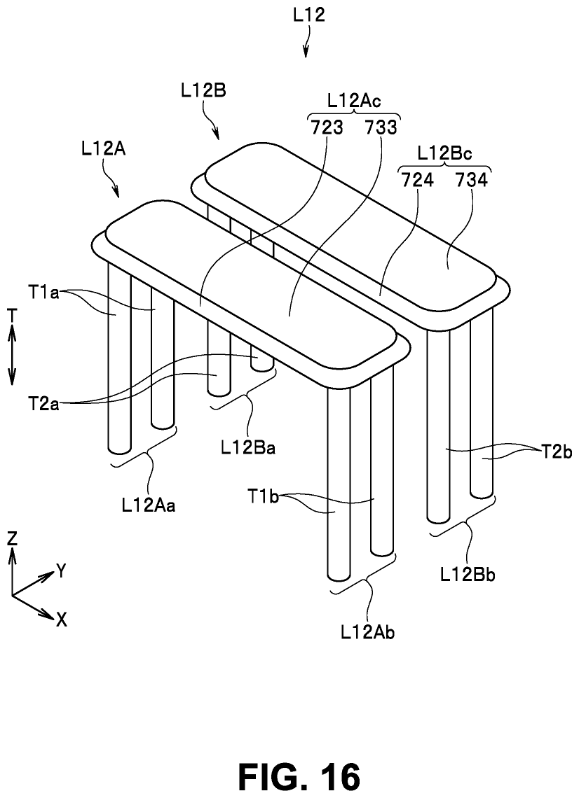

Next, with reference to FIG. 16, the second variation of the inductor L12 will be described. In the second variation, the first structure L12Aa of the first inductor portion L12A is constituted by two columnar conductors T1a, and the second structure L12Ab of the first inductor portion L12A is constituted by two columnar conductors T1b. In the second variation, the number of the columnar conductors in the first inductor portion L12A is four, which is the same as the number of the columnar conductors in the second inductor portion L12B.

In the second variation, the short-side-direction size of the third structure L12Ac of the first inductor portion L12A may be the same as or approximately the same as the short-side-direction size of the third structure L12Bc of the second inductor portion L12B.

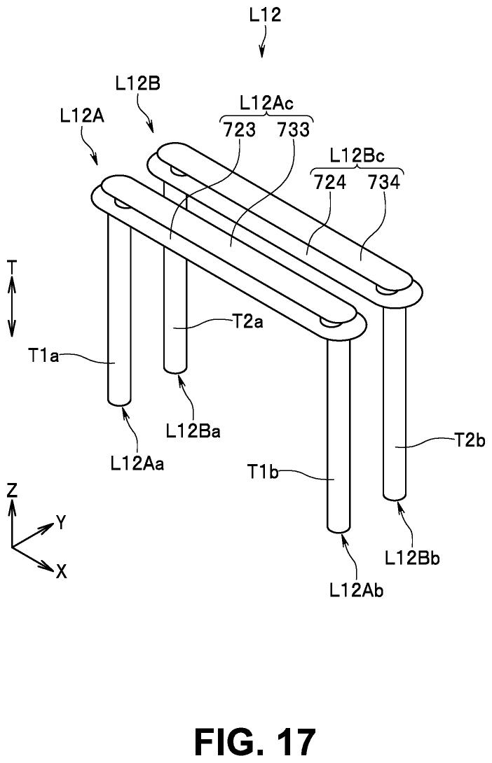

Next, with reference to FIG. 17, the third variation of the inductor L12 will be described. In the third variation, the first structure L12Aa of the first inductor portion L12A is constituted by one columnar conductor T1a, and the second structure L12Ab of the first inductor portion L12A is constituted by one columnar conductor T1b. In the third variation, as in the first variation, the first structure L12Ba of the second inductor portion L12B is constituted by one columnar conductor T2a, and the second structure L12Bb of the second inductor portion L12B is constituted by one columnar conductor T2b. In the third variation, the number of the columnar conductors in the first inductor portion L12A and the number of the columnar conductors in the second inductor portion L12B are both two.

In the third variation, the short-side-direction size of the third structure L12Ac of the first inductor portion L12A may be the same as or approximately the same as the short-side-direction size of the third structure L12Bc of the second inductor portion L12B.

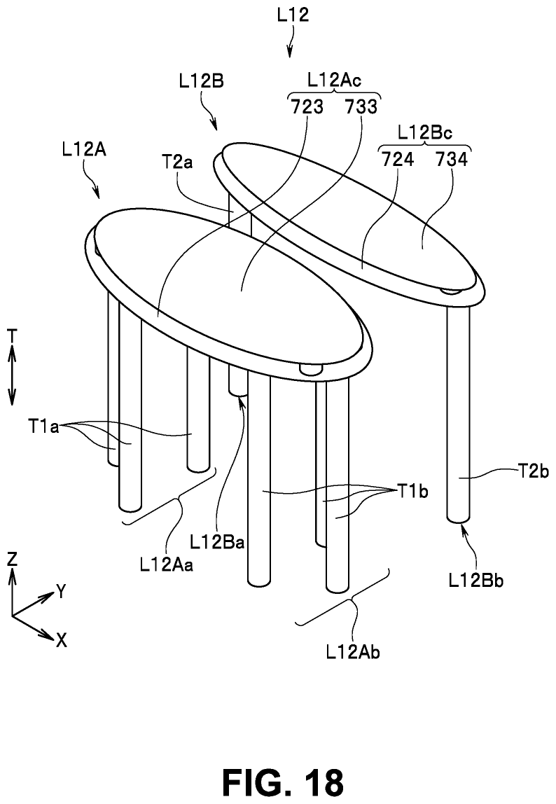

Next, with reference to FIG. 18, the fourth variation of the inductor L12 will be described. In the fourth variation, the plane shape (shape when viewed in the stacking direction T) of each of the conductor layers 723 and 733 constituting the third structure L12Ac of the first inductor portion L12A is approximately elliptic. The plane shape of each of the conductor layers 724 and 734 constituting the third structure L12Bc of the second inductor portion L12B is approximately elliptic.

In the fourth variation, two −Y-direction side columnar conductors T1a of the three columnar conductors T1a constituting the first structure L12Aa of the first inductor portion L12A are arranged in the direction intersecting the direction parallel to the Y direction (direction parallel to a direction obtained by rotating from the X direction toward the −Y direction). Two Y-direction side columnar conductors T1a of the three columnar conductors T1a constituting the first structure L12Aa of the first inductor portion L12A are arranged in the direction intersecting the direction parallel to the Y direction (direction parallel to a direction obtained by rotating from the X direction toward the Y direction). In other words, in the fourth variation, the first structure L12Aa includes two pairs of columnar conductors T1a arranged in the direction intersecting the short-side direction of the third structure L12Ac (direction parallel to the Y direction).

The above description about the first structure L12Aa also applies to the second structure L12Ab of the first inductor portion L12A. In the fourth variation, the second structure L12Ab includes two pairs of columnar conductors T1a arranged in the direction intersecting the short-side direction of the third structure L12Ac (direction parallel to the Y direction).

In the fourth variation, the first structure L12Ba of the second inductor portion L12B is constituted by one columnar conductor T2a, and the second structure L12Bb of the second inductor portion L12B is constituted by one columnar conductor T2b.

The present invention is not limited to the foregoing embodiment, and various modifications may be made thereto. For example, the multilayer inductor of the present invention is applicable not only to a branching filter but also to other multilayered electronic components such as a multilayered low-pass filter and a multilayered band-pass filter. The multilayer inductor of the present invention may be a discrete product as an inductor.

The arrangement and posture of each of the inductors L12 and L22 are not limited to the examples described in the embodiment and may be optional as long as the requirements set forth in the claims are met. For example, at least one of the first and second axes A1 and A2 may extend in a direction intersecting a direction parallel to the Y direction.

The number of the windings of the inductor L12 (L22) is not limited to ¾ and may be any number of windings equal to or larger than one. In other words, the number of windings of each of the first and second inductor portions L12A and L12B (L22A and L22B) of the inductor L12 may be any number of windings equal to or larger than one.

The inductor L12 (L22) may include one or more third inductor portions in addition to the first and second inductor portions L12A and L12B (L22A and L22B). The first and second inductor portions L12A and L12B (L22A and L22B) and the one or more third inductor portions are connected in parallel with each other. The one or more third inductor portions may each include conductor structures including the first to third structures as the first and second inductor portions L12A and L12B (L22A and L22B) do.

As described above, a multilayer inductor of a first aspect of the present invention includes a first inductor portion, a second inductor portion connected in parallel with the first inductor portion, and a stack for integrating the first inductor portion and the second inductor portion, the stack including a plurality of dielectric layers stacked together. Each of the first inductor portion and the second inductor portion includes a conductor structure wound about an axis extending in a direction orthogonal to a stacking direction of the plurality of dielectric layers. The conductor structure includes a first structure and a second structure each extending in a direction parallel to the stacking direction and a third structure extending along a plane intersecting the stacking direction and provided between the first structure and the second structure in a circuit configuration.

Each of the first structure and the second structure includes at least one columnar conductor extending in the direction parallel to the stacking direction. The at least one columnar conductor of at least one of the first structure and the second structure of the first inductor portion includes a plurality of columnar conductors arranged with certain space from each other in the direction orthogonal to the stacking direction.

In the multilayer inductor of the first aspect of the present invention, the at least one columnar conductor of at least one of the first structure and the second structure of the second inductor portion may include a plurality of columnar conductors arranged with certain space from each other in the direction orthogonal to the stacking direction. The number of the at least one columnar conductor in the first inductor portion may be larger than the number of the at least one columnar conductor in the second inductor portion. Alternatively, the number of the at least one columnar conductor in the first inductor portion may be the same as the number of the at least one columnar conductor in the second inductor portion.

In the multilayer inductor of the first aspect of the present invention, the number of the at least one columnar conductor in the second inductor portion may be two.

In the multilayer inductor of the first aspect of the present invention, at least one of the at least one columnar conductor of the first structure and the at least one columnar conductor of the second structure may include a plurality of columnar conductors arranged in a short-side direction of the third structure.

In the multilayer inductor of the first aspect of the present invention, at least one of the at least one columnar conductor of the first structure and the at least one columnar conductor of the second structure may include a plurality of columnar conductors arranged in a direction intersecting the short-side direction of the third structure.

In the multilayer inductor of the first aspect of the present invention, the at least one columnar conductor of the first structure of the first inductor portion and the at least one columnar conductor of the first structure of the second inductor portion may be arranged in the direction orthogonal to the stacking direction. The at least one columnar conductor of the second structure of the first inductor portion and the at least one columnar conductor of the second structure of the second inductor portion may be arranged in the direction orthogonal to the stacking direction.

In the multilayer inductor of the first aspect of the present invention, the short-side-direction size of the third structure of the first inductor portion may be larger than the short-side-direction size of the third structure of the second inductor portion.

In the multilayer inductor of the first aspect of the present invention, the third structure of the first inductor portion and the third structure of the second inductor portion may be arranged at the same position in the stacking direction.

In the multilayer inductor of the first aspect of the present invention, the third structure may include a plurality of conductor layers stacked together in the stacking direction and electrically connected to each other.

A multilayer inductor of a second aspect of the present invention includes a stack including a plurality of dielectric layers stacked together and an inductor integrated into the stack. The inductor includes a plurality of columnar conductors and a plurality of conductor layers. The plurality of conductor layers include a first conductor layer and a second conductor layer arranged with certain space from each other when viewed in a stacking direction of the plurality of dielectric layers. The plurality of columnar conductors include two first columnar conductors electrically connected by the first conductor layer and two second columnar conductors electrically connected by the second conductor layer.

Obviously, many modifications and variations of the present invention are possible in the light of the above teachings. Thus, it is to be understood that, within the scope of the appended claims and equivalents thereof, the present invention may be practiced in other embodiments than the foregoing most preferable embodiment.

What is claimed is:

1. A multilayer inductor comprising:
a first inductor portion;
a second inductor portion connected in parallel with the first inductor portion; and
a stack for integrating the first inductor portion and the second inductor portion, the stack including a plurality of dielectric layers stacked together, wherein
each of the first inductor portion and the second inductor portion includes a conductor structure wound about an axis extending in a direction orthogonal to a stacking direction of the plurality of dielectric layers,
the conductor structure includes a first structure and a second structure each extending in a direction parallel to the stacking direction and a third structure extending along a plane intersecting the stacking direction and provided between the first structure and the second structure in a circuit configuration,
each of the first structure and the second structure includes at least one columnar conductor extending in the direction parallel to the stacking direction, and
the at least one columnar conductor of at least one of the first structure or the second structure of the first inductor portion includes a plurality of columnar conductors arranged with certain space from each other in the direction orthogonal to the stacking direction.

2. The multilayer inductor according to claim 1, wherein the at least one columnar conductor of at least one of the first structure or the second structure of the second inductor portion includes a plurality of columnar conductors arranged with certain space from each other in the direction orthogonal to the stacking direction.

3. The multilayer inductor according to claim 2, wherein the number of the at least one columnar conductor in the first inductor portion is larger than the number of the at least one columnar conductor in the second inductor portion.

4. The multilayer inductor according to claim 2, wherein the number of the at least one columnar conductor in the first inductor portion is the same as the number of the at least one columnar conductor in the second inductor portion.

5. The multilayer inductor according to claim 1, wherein the number of the at least one columnar conductor in the second inductor portion is two.

6. The multilayer inductor according to claim 1, wherein at least one of the at least one columnar conductor of the first structure or the at least one columnar conductor of the second structure includes a plurality of columnar conductors arranged in a short-side direction of the third structure.

7. The multilayer inductor according to claim 1, wherein at least one of the at least one columnar conductor of the first structure or the at least one columnar conductor of the second structure includes a plurality of columnar conductors arranged in a direction intersecting a short-side direction of the third structure.

8. The multilayer inductor according to claim 1, wherein
the at least one columnar conductor of the first structure of the first inductor portion and the at least one columnar conductor of the first structure of the second inductor portion are arranged in the direction orthogonal to the stacking direction, and
the at least one columnar conductor of the second structure of the first inductor portion and the at least one columnar conductor of the second structure of the second inductor portion are arranged in the direction orthogonal to the stacking direction.

9. The multilayer inductor according to claim 1, wherein short-side-direction size of the third structure of the first inductor portion is larger than short-side-direction size of the third structure of the second inductor portion.

10. The multilayer inductor according to claim 1, wherein the third structure of the first inductor portion and the third structure of the second inductor portion are arranged at a same position in the stacking direction.

11. The multilayer inductor according to claim 1, wherein the third structure includes a plurality of conductor layers stacked together in the stacking direction and electrically connected to each other.

12. A multilayer inductor comprising:
a stack including a plurality of dielectric layers stacked together; and
an inductor integrated into the stack, wherein
the inductor includes a plurality of columnar conductors and a plurality of conductor layers,
the plurality of conductor layers include a first conductor layer and a second conductor layer arranged with certain space from each other when viewed in a stacking direction of the plurality of dielectric layers, and
the plurality of columnar conductors include two first columnar conductors electrically connected by the first conductor layer and two second columnar conductors electrically connected by the second conductor layer.
